(19) United States
(12) Patent Application Publication
(10) Pub. No.: US 2026/0045729 A1
(43) Pub. Date: Feb. 12, 2026

(54) CONNECTOR

(71) Applicant: Yazaki Corporation, Tokyo (JP)

(72) Inventors: Yuuhei Takeshita, Makinohara-shi (JP); Koki Iwakura, Makinohara-shi (JP); Yasuo Shimizu, Makinohara-shi (JP); Toshikazu Yoshioka, Makinohara-shi (JP); Moeto Osawa, Fujieda-shi (JP)

(21) Appl. No.: 19/289,500

(22) Filed: Aug. 4, 2025

(30) Foreign Application Priority Data
Aug. 7, 2024 (JP) 2024-130759

(51) Int. Cl. H01R 13/506

(52) U.S. Cl. CPC H01R 13/506

(57) ABSTRACT

A connector includes a housing, a shell, and a holder. The housing has a terminal support that supports a terminal, and an electric wire accommodator through which the electric wire connected to the terminal passes. The shell is fitted on an outer side of the electric wire accommodator from an opposite side of the terminal support.

The holder holds the electric wire and is fitted in an inner side of the electric wire accommodator. The housing has a locking lance that extends along an inner surface of the shell and engages with the shell. The holder has a crush rib that is disposed inside the electric wire accommodator and pressurizes the locking lance toward the inner surface of the shell.

### BACKGROUND OF THE INVENTION

### Field of the Invention

The embodiments of the present invention relate to a connector.

The present application claims priority based on Japanese Patent Application No. 2024-130759 filed in Japan on Aug. 7, 2024, the contents of which are incorporated herein by reference.

### Description of Related Art

Connectors include a housing that holds a terminal connected to an electric wire, and a holder that holds the electric wire and is assembled to the housing.

### PRIOR ART DOCUMENT

### Patent Document

Patent Document 1: Japanese Unexamined Patent Application, First Publication No. 2022-107260

Patent Document 2: Japanese Unexamined Patent Application, First Publication No. 2024-47725

### SUMMARY OF THE INVENTION

Incidentally, in connectors in the related art, it is desired to suppress transmission of vibration from an electric wire to a terminal.

An embodiment is configured to provide a connector capable of suppressing transmission of vibration from an electric wire to a terminal.

A connector according to an embodiment includes a housing, a shell, and a holder. The housing has a terminal support that supports a terminal, and an electric wire accommodator through which the electric wire connected to the terminal passes. The shell is fitted on an outer side of the electric wire accommodator from an opposite side of the terminal support. The holder holds the electric wire and is fitted in an inner side of the electric wire accommodator. The housing has a locking lance that extends along an inner surface of the shell and engages with the shell. The holder has a crush rib that is disposed inside the electric wire accommodator and pressurizes the locking lance toward the inner surface of the shell.

According to one embodiment, it is possible to suppress transmission of vibration from the electric wire to the terminal.

### BRIEF DESCRIPTION OF THE DRAWINGS

FIG. 1 is a perspective view illustrating a connector 1 of an embodiment.

FIG. 2 is an exploded perspective view illustrating the connector 1 of the embodiment.

FIG. 3 is a plan view illustrating the connector 1 of the embodiment.

FIG. 4 is a cross-sectional view illustrating the connector 1 of the embodiment.

FIG. 5 is a perspective view illustrating a housing 10 of the embodiment.

FIG. 6 is a cross-sectional view taken along line VI-VI in FIG. 3.

FIG. 7 is a perspective view illustrating a rear holder 60 of the embodiment.

FIG. 8 is a cross-sectional view taken along line VIII-VIII in FIG. 3.

FIG. 9 is a cross-sectional view taken along line IX-IX in FIG. 3.

### DETAILED DESCRIPTION OF THE INVENTION

Hereinafter, embodiments will be described with reference to the drawings. In the following description, constitutions having the same or similar functions are denoted by the same reference numbers.

In the present application, terms are defined as follows. The term “connection” is not limited to a mechanical connection, and may include an electrical connection. That is, “connection” is not limited to a case where two elements which are connection targets are directly connected, and may include a case where two elements which are connection targets are connected with another element interposed therebetween. The term “to restrict” is not limited to a case where two members are in constant contact with each other, thereby restricting movement of one member with respect to the other member. The term “to restrict” may include, for example, a case where two members are not in contact with each other in a state in which no positional shift occurs, but the two members are brought into contact with each other when one of the two members is caused to be shifted with respect to the other, thereby restricting movement of one of the two members with respect to the other. In addition, “to restrict” means that movement in at least one direction is restricted.

Hereinafter, a right-handed XYZ coordinate system illustrated in each drawing is defined. An X direction, a Y direction, and a Z direction are defined as follows. The X direction is a fitting direction of a connector 1 in a mating connector. A +X direction is a direction from the connector 1 to the mating connector. The Y direction is a direction intersecting (in the present embodiment, a direction orthogonal to) the X direction and is a direction in which terminals 40 to be described below are arranged. The Z direction is a direction intersecting (in the present embodiment, a direction orthogonal to) the X direction and the Y direction. In addition, hereinafter, for convenience of description, the +X direction may be referred to as a “front side”, and a −X direction may be referred to as a “rear side”.

### Embodiments

The connector 1 of an embodiment is a connection component for electrically connecting an electric wire 41 and a terminal fitting provided in a mating connector (not illustrated). Regarding the connector 1, for example, the connector 1 is used for a vehicle such as an electric vehicle (EV), a hybrid electric vehicle (HEV), or a plug-in hybrid electric vehicle (PHEV). The connector 1 is, for example, a high-voltage connector in which a current of 100 V or higher flows. However, the connector 1 may be a low-voltage connector. Regarding the connector 1 in the present embodiment, the connector 1 corresponds to three electrodes. However, regarding the connector 1, the connector 1 may correspond to two or less electrodes, or the connector 1 may correspond to four or more electrodes.

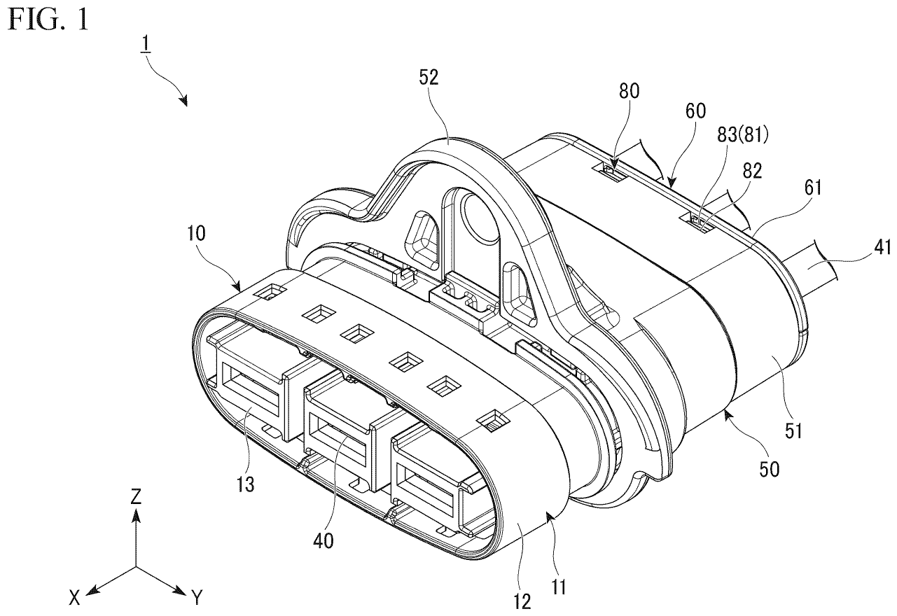

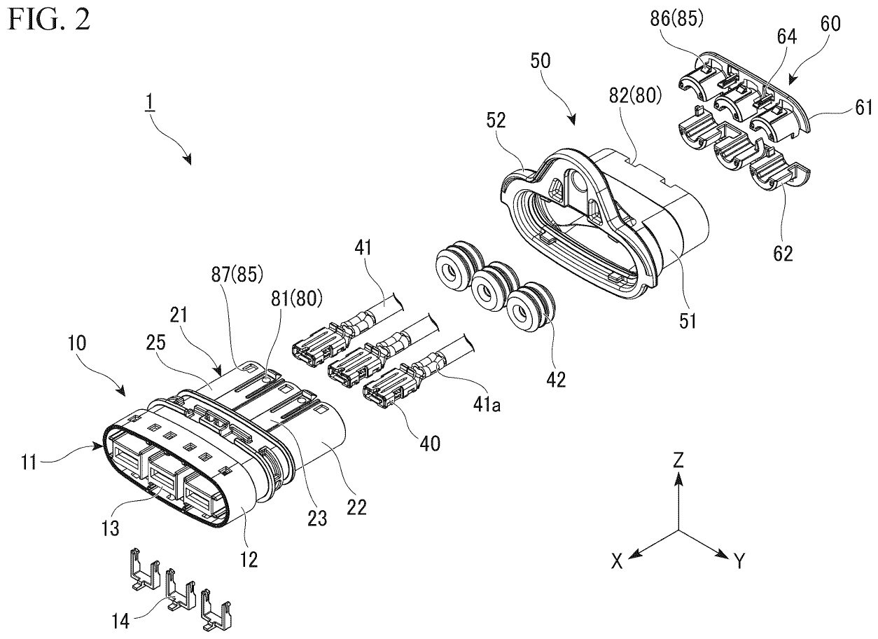

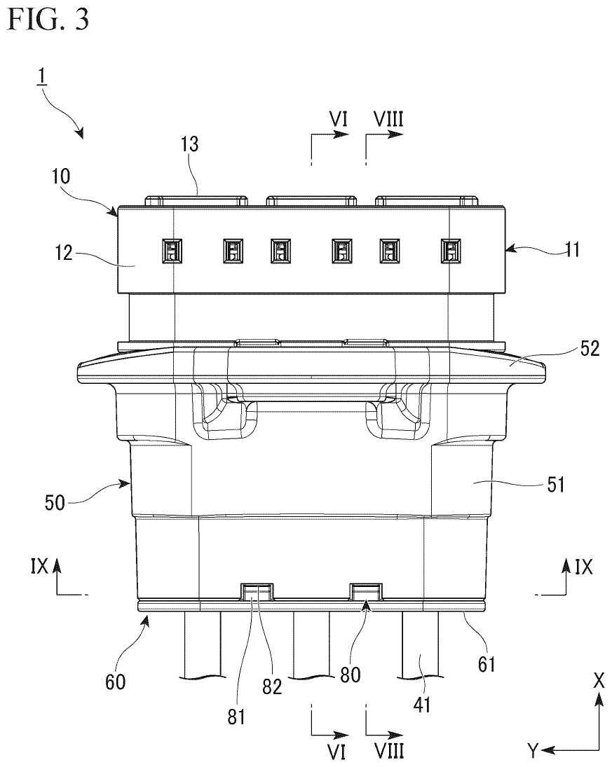

FIG. 1 is a perspective view illustrating the connector 1 of the embodiment. FIG. 2 is an exploded perspective view illustrating the connector 1 of the embodiment. FIG. 3 is a plan view illustrating the connector 1 of the embodiment.

As illustrated in FIGS. 1 to 3, the connector 1 includes a housing 10, the terminal 40, a shell 50, and a rear holder 60. The rear holder 60 is an example of a “holder”.

The housing 10 is a member that is to be coupled to the mating connector. For example, the housing 10 is made of a synthetic resin. The housing 10 has an insulating property. The housing 10 includes a front portion 11 that supports the terminal 40, and an electric wire accommodator 21 through which the electric wire 41 connected to the terminal 40 passes. The front portion 11 is an example of a “terminal support”.

The front portion 11 is a part of the housing 10 that is coupled to the mating connector. The front portion 11 includes a terminal accommodator 13 that accommodates the terminal 40 and a hood 12 that covers the terminal accommodator 13. Note that a shape of the front portion 11 to be described below is an example, and the shape of the front portion is not particularly limited.

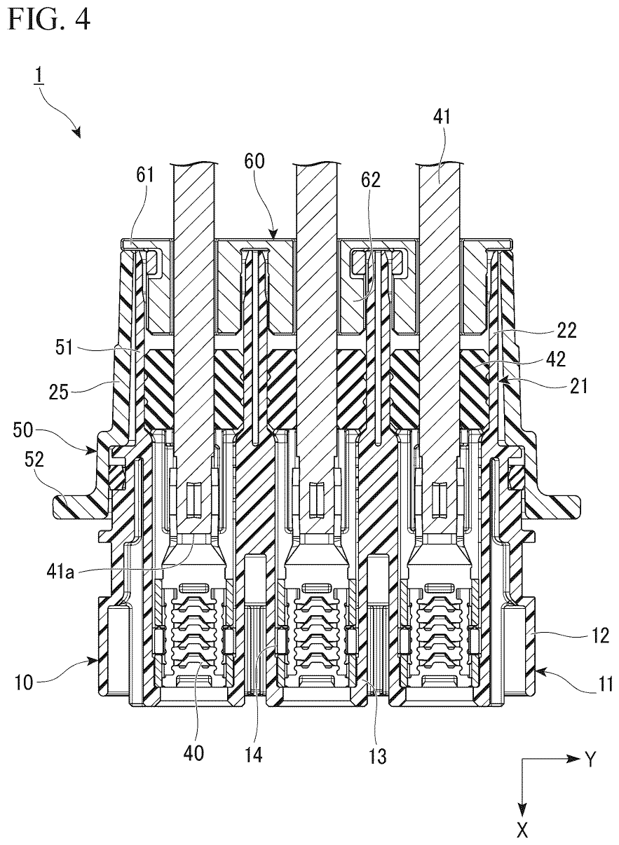

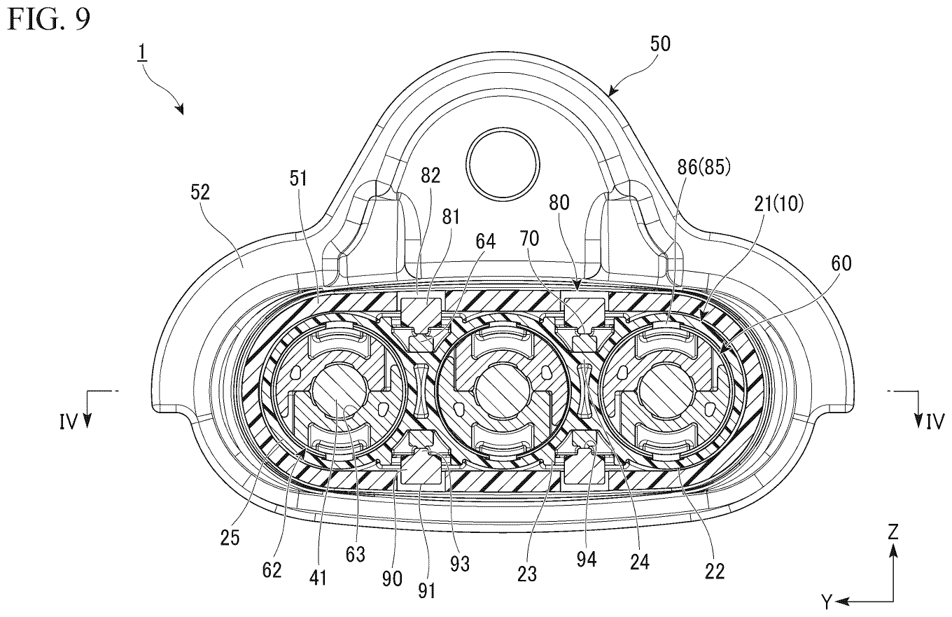

FIG. 4 is a cross-sectional view illustrating the connector 1 of the embodiment and illustrates a cross section at a position taken along line IV-IV in FIG. 9.

As illustrated in FIGS. 2 and 4, the hood 12 is formed in a bottomed cylindrical shape having a circumferential wall portion and a bottom wall portion and is open in the +X direction for connection to the mating connector. The hood 12 has an oval cylinder shape having a major axis along the Y direction. Note that, in the present embodiment, the oval may be read as an ellipse. An annular seal member can be attached to an outer circumference of the hood 12.

The terminal accommodator 13 supports the terminal 40 so that the terminal cannot be relatively displaced. The number of terminal accommodators 13 is the same as the number of terminals 40, and the terminal accommodators 13 hold the terminals 40 in one-to-one. The terminal accommodators 13 are arranged in the Y direction on an inner side of the hood 12. The terminal accommodator 13 has a cylindrical shape extending in the X direction. The terminal accommodator 13 has a quadrangular cylinder shape. The terminal accommodator 13 penetrates a bottom wall of the hood 12. The terminal 40 is disposed in an inside of the terminal accommodator 13. The inside of the terminal accommodator 13 is open in the +X direction for connection of the terminal 40 to the terminal 40 of the mating connector. In addition, the inside of the terminal accommodator 13 is open in the −X direction to pull out the electric wire 41 rearward from the front portion 11. The terminal 40 is inserted into an inner side of the terminal accommodator 13 in the +X direction through the electric wire accommodator 21 in a state of being connected to the electric wire 41. The terminal 40 is locked to the terminal accommodator 13 by a spacer 14. The spacer 14 is disposed to fill gaps in the Y direction between the terminal 40 and side walls of the terminal accommodator 13 on both sides in the Y direction.

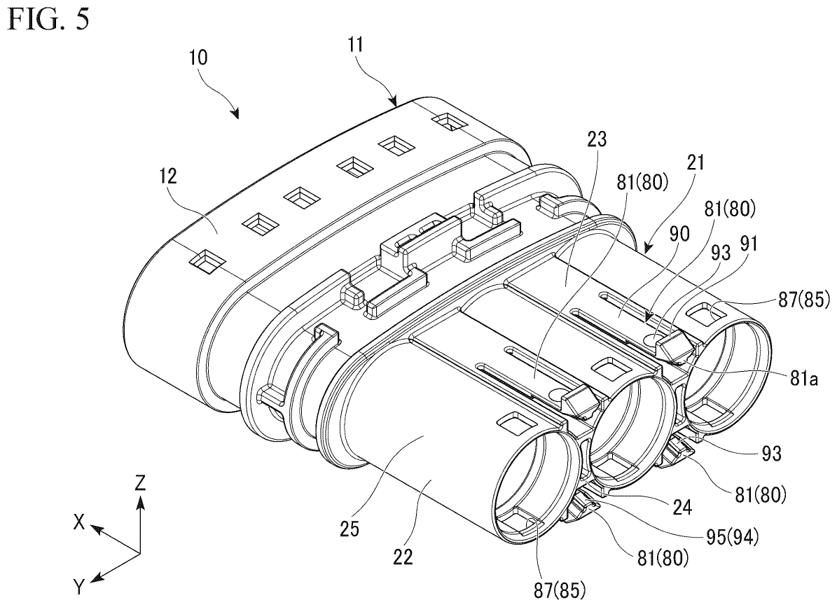

FIG. 5 is a perspective view illustrating the housing 10 of the embodiment.

As illustrated in FIGS. 4 and 5, the electric wire accommodator 21 projects from the front portion 11 in the −X direction. The electric wire accommodator 21 includes a circular cylinder 22, an outer linker 23, and an inner linker 24. The inner linker 24 is an example of a “contact portion”.

The circular cylinder 22 extends in the X direction. A plurality of (three in the present embodiment) circular cylinders 22 are provided in one-to-one correspondence with the electric wires 41. The plurality of circular cylinders 22 are arranged in the Y direction. The circular cylinder 22 is continuous to an end portion of the terminal accommodator 13 in the −X direction. The inside of the circular cylinder 22 communicates with the inside of the terminal accommodator 13. The electric wire 41 passes through an inner side of the circular cylinder 22. An opening of the circular cylinder 22 in the −X direction is a pull-out port through which the electric wire 41 is pulled out to the outside of the housing 10. When the terminal 40 is assembled to the housing 10, the terminal 40 connected to the electric wire 41 is inserted into the opening of the circular cylinder 22 in the −X direction.

The outer linker 23 is formed in a plate shape extending along an XY plane. The outer linker 23 connects a pair of adjacent circular cylinders 22 to each other. The outer linker 23 is disposed to cover a space between the pair of adjacent circular cylinders 22 from an outer side in the Z direction. That is, two outer linkers 23 are provided for the pair of adjacent circular cylinders 22, and four outer linkers are provided in the present embodiment. The outer linker 23 extends in the −X direction from the bottom wall portion of the hood 12. Side edges of the outer linker 23 on both sides in the Y direction extend in the X direction and are coupled to outer circumferential surfaces of the circular cylinders 22 over the entire length thereof. An end edge of the outer linker 23 in the −X direction extends in the Y direction and is located, in the X direction, at the same position as an end portion of the circular cylinder 22 in the −X direction.

The inner linker 24 connects the pair of adjacent circular cylinders 22 to each other. The inner linker 24 is disposed between the pair of outer linkers 23 adjacent to each other in the Z direction. The two inner linkers 24 are provided for the pair of adjacent circular cylinders 22, and four inner linkers are provided in the present embodiment. The two inner linkers 24 are adjacent to each other at an interval in the Z direction between the pair of adjacent circular cylinders 22. The two inner linkers 24 have gaps in the Z direction from the outer linkers 23. The inner linker 24 extends in the −X direction from the bottom wall portion of the hood 12. Side edges of the inner linker 24 on both sides in the Y direction extend in the X direction and are coupled to outer circumferential surfaces of the circular cylinders 22 over the entire length thereof. An end edge of the inner linker 24 in the −X direction extends in the Y direction and is located, in the X direction, at the same position as the end portion of the outer linker 23 in the −X direction.

As illustrated in FIG. 5, the entire electric wire accommodator 21 is formed in an oval cylinder shape having a major axis along the Y direction. The electric wire accommodator 21 has an outer circumferential wall portion 25 forming an outer circumferential surface of the electric wire accommodator 21. The outer circumferential wall portion 25 is formed by the outer linker 23 and a part of the circular cylinder 22.

As illustrated in FIG. 4, the electric wire 41 has a first end portion 41a that is directly connected to the terminal 40 on an inner side of the housing 10. At the first end portion 41a of the electric wire 41, a core wire of the electric wire 41 is fastened to the terminal 40. The core wire of the electric wire 41 is fastened to the terminal 40 by caulking. However, the core wire of the electric wire 41 may be connected to the terminal 40 by a method other than caulking. The electric wire 41 extends from the first end portion 41a in the −X direction on an inner side of the circular cylinder 22 and is pulled to the outside of the housing 10. A grommet 42 is attached to the electric wire 41. The grommet 42 is disposed inside the circular cylinder 22. The grommet 42 is in close contact with both an outer circumferential surface of the electric wire 41 and an inner circumferential surface of the circular cylinder 22 over the entire circumferences thereof.

The shell 50 is fixed to the housing 10 and is formed to be fixable to the mating connector. The shell 50 is provided to cover the electric wire accommodator 21. The shell 50 is fitted on an outer side of the electric wire accommodator 21 from an opposite side (the −X direction) to the front portion 11. The +X direction is an assembling direction of the shell 50 with respect to the electric wire accommodator 21. The shell 50 includes an enclosure 51 and a flange 52.

The enclosure 51 is disposed over the entire outer circumference of the outer circumferential wall portion 25 of the electric wire accommodator 21. The enclosure 51 is formed in an oval cylinder shape having a major axis along the Y direction corresponding to the shape of the outer circumferential wall portion 25. An inner circumferential surface of the enclosure 51 is close to an outer circumferential surface of the outer circumferential wall portion 25. An end edge of the enclosure 51 in the −X direction is located, in the X direction, at substantially the same position as an end edge of the outer circumferential wall portion 25 in the −X direction. The end edge of the enclosure 51 in the −X direction may be located, in the X direction, at a position in the −X direction from an end edge of the electric wire accommodator 21 in the −X direction. The enclosure 51 is disposed from a periphery of the electric wire accommodator 21 to a periphery of the front portion 11.

As illustrated in FIGS. 2 and 4, the flange 52 protrudes outward along a direction orthogonal to the X direction from an end edge of the enclosure 51 in the +X direction. The flange 52 extends over the entire circumference of the enclosure 51. The flange 52 has a screw hole into which a screw is inserted. The screw is screwed into the mating connector or a member around the mating connector. That is, the flange 52 is fastened to the mating connector or a member around the mating connector.

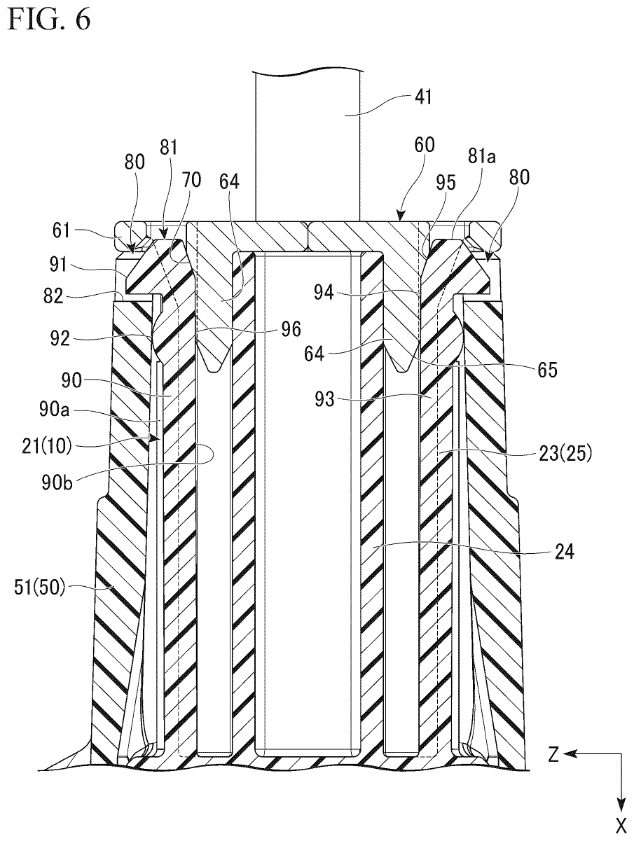

FIG. 6 is a cross-sectional view taken along line VI-VI in FIG. 3.

As illustrated in FIGS. 3 and 6, the shell 50 and the housing 10 include first engagement portions 80 that engage with each other. A plurality of first engagement portions 80 are provided in the Z direction and a plurality of first engagement portions 80 are provided in the Y direction. The first engagement portion 80 includes a first locking lance 81 provided in the housing 10 and a first locking recess 82 provided in the shell 50. The first locking lance 81 is an example of a “locking lance”.

As illustrated in FIG. 5, the first locking lance 81 is provided at the outer circumferential wall portion 25 of the electric wire accommodator 21 of the housing 10. The first locking lance 81 is a portion between a pair of notches extending in the +X direction from an end edge of the outer linker 23 in the −X direction and is formed in a cantilever shape having an end portion in the +X direction as a base end (a fixed end). The first locking lance 81 has, at a tip end thereof, a tip end surface 81a facing the −X direction. The first locking lance 81 includes an arm 90, a first lance projection 91, a protrusion 92, and an inner rib 93.

As illustrated in FIGS. 5 and 6, the arm 90 is formed in a plate shape having a thickness in the Z direction. The arm 90 can be bent in the Z direction. The first lance projection 91 is a claw of the first locking lance 81. The first lance projection 91 is provided at the tip end of the first locking lance 81. The first lance projection 91 projects outward from a first surface 90a facing an outer side of the arm 90 toward the enclosure 51. The first lance projection 91 projects outward in the Z direction from the outer circumferential wall portion 25. The arm 90 is bent in the Z direction, thereby enabling the first lance projection 91 to be elastically displaced inward to be separated from the enclosure 51.

The protrusion 92 is provided separately from the first lance projection 91. The protrusion 92 projects outward from the first surface 90a facing the outer side of the arm 90 toward the enclosure 51. The protrusion 92 projects outward in the Z direction from the outer circumferential wall portion 25. The protrusion 92 is provided at an interval in the X direction with respect to a base end of the arm 90. The protrusion 92 is formed at a position closer to the base end of the first locking lance 81 than the first lance projection 91 is. The protrusion 92 is formed in a spherical segment shape (a shape obtained by cutting out a part of a sphere). However, the shape of the protrusion 92 is not particularly limited. For example, the protrusion 92 may come into contact with the inner circumferential surface of the enclosure 51, thereby being deformed. The inner rib 93 is provided on a second surface 90b facing an inner side of the arm 90. The inner rib 93 projects inward from the second surface 90b and extends from a tip end toward the base end of the arm 90.

As illustrated in FIG. 6, an inner end edge of the first locking lance 81 includes an inclined portion 95 extending inward from the tip end of the first locking lance 81 toward the +X direction. In the present embodiment, the inner end edge of the first locking lance 81 is a projection end of the inner rib 93 which extends along an extension direction of the inner rib 93. However, in a case where the first locking lance 81 does not have the inner rib 93, the inner end edge of the first locking lance 81 may be the second surface 90b of the arm 90.

As illustrated in FIGS. 3 and 6, the first locking recess 82 is provided in the enclosure 51 of the shell 50. The first locking recess 82 is open in the inner circumferential surface of the enclosure 51. The first locking recess 82 is formed at a position opposite to the first lance projection 91 in the inner circumferential surface of the enclosure 51. In the present embodiment, the first locking recess 82 penetrates the enclosure 51 in a thickness direction of the enclosure 51 and is open at the end edge of the enclosure 51 in the −X direction.

As illustrated in FIG. 6, in a completely fitted state of the housing 10 and the shell 50, the first lance projection 91 enters the first locking recess 82. An opening edge of the first locking recess 82 engages with the first lance projection 91 from the +X direction, thereby restricting movement of the shell 50 in the −X direction with respect to the housing 10. In a state in which the first lance projection 91 enters the first locking recess 82, the protrusion 92 abuts on the inner circumferential surface of the enclosure 51 from the inner side. On the other hand, in a half-fitted state of the housing 10 and the shell 50, the first lance projection 91 is in sliding contact with a position on the inner circumferential surface of the enclosure 51 which is around the first locking recess 82 and does not engage with the first locking recess 82. In a state in which the first lance projection 91 is in sliding contact with the inner circumferential surface of the enclosure 51, the protrusion 92 is separated inward from the inner circumferential surface of the enclosure 51.

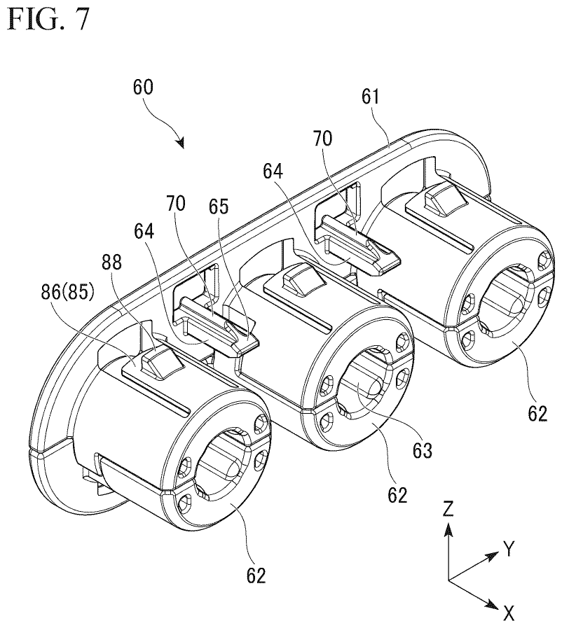

FIG. 7 is a perspective view illustrating a rear holder 60 of the embodiment.

As illustrated in FIGS. 4 and 7, the rear holder 60 holds the flexible electric wire 41. The rear holder 60 is disposed in the housing 10 and the shell 50 so as not to be relatively displaced. The rear holder 60 is assembled to the housing 10 in the +X direction. The rear holder 60 is fitted in an inner side of the electric wire accommodator 21 and directly fixed to the housing 10. The rear holder 60 includes a blocker 61 and an insertion portion 62.

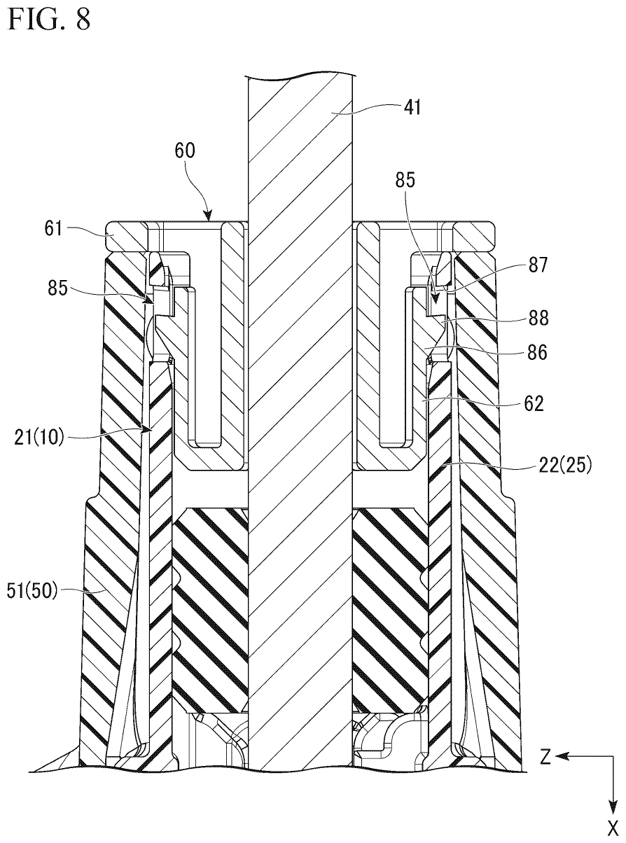

FIG. 8 is a cross-sectional view taken along line VIII-VIII in FIG. 3.

As illustrated in FIGS. 4 and 8, the blocker 61 is formed to cover the entire end portion of the electric wire accommodator 21 in the −X direction and the entire end portion of the enclosure 51 of the shell 50 in −X direction. The blocker 61 is formed in an oval plate shape having a major axis along the Y direction when viewed from the X direction, corresponding to a shape of an opening edge of the enclosure 51 in the −X direction (an end edge in the −X direction) (see FIG. 7). An outer circumferential portion of the blocker 61 faces the opening edge of the enclosure 51 in the −X direction over the entire circumference (see FIG. 3). The outer circumferential portion of the blocker 61 is adjacent to the opening edge of the enclosure 51 in the −X direction with substantially no gap therebetween. However, the outer circumferential portion of the blocker 61 may be close to the opening edge of the enclosure 51 in the −X direction with a slight gap. The blocker 61 is adjacent to the opening edge of the enclosure 51 in the −X direction with substantially no gap, thereby enabling that the rear holder 60 is disposed at a normal position with respect to the shell 50 and the housing 10 to be identified from outside.

As illustrated in FIGS. 4 and 7, the insertion portion 62 is inserted into an inner side of the circular cylinder 22 of the electric wire accommodator 21 from the opposite side to the front portion 11. The number of insertion portions 62 is the same as the number of circular cylinders 22, and the insertion portions are inserted into the inner side of the circular cylinders 22 one by one. The insertion portion 62 is formed in a circular cylinder shape extending in the X direction corresponding to an inner shape of the circular cylinder 22.

FIG. 9 is a cross-sectional view taken along line IX-IX in FIG. 3.

As illustrated in FIG. 9, a protrusion 63 is formed on an inner circumferential surface of the insertion portion 62. The electric wire 41 passes through an inner side of the insertion portion 62. The protrusion 63 is embedded in a sheath of the electric wire 41, thereby causing the insertion portion 62 to hold the electric wire 41 so as not to be displaced.

As illustrated in FIGS. 6 and 7, the rear holder 60 includes a restrictor 64 inserted into an inner side of the outer circumferential wall portion 25 of the electric wire accommodator 21 from the opposite side to the front portion 11. The restrictor 64 is disposed inside the first locking lance 81. The restrictor 64 projects in the +X direction from the blocker 61 toward an inside of the outer circumferential wall portion 25. The restrictors 64 are provided in one-to-one correspondence with the first lance projections 91. The restrictor 64 is inserted between the first locking lance 81 and the inner linker 24. The restrictor 64 is in direct contact with the first locking lance 81 and restricts displacement of the first locking lance 81 in a direction (inward) away from the enclosure 51. The restrictor 64 is in direct contact with the inner linker 24 and is restricted from being displaced to a side (inward) away from the first locking lance 81. That is, the inner linker 24 is in contact with the restrictor 64 from the opposite side to the first locking lance 81 with respect to the restrictor 64.

The restrictor 64 has a crush rib 70 which pressurizes the first locking lance 81 toward the inner circumferential surface of the enclosure 51. The crush rib 70 projects outward from a main body of the restrictor 64 toward the first locking lance 81 and extends in the −X direction from a tip end portion of the restrictor 64. The crush rib 70 projects outward in the Z direction. A thickness of the crush rib 70 in the Y direction is smaller than a width of the first locking lance 81 in the Y direction. The crush rib 70 is crushed in a process of inserting the restrictor 64 between the first locking lance 81 and the inner linker 24 and comes into pressure contact with the first locking lance 81. The crush rib 70 is in contact with a protrusion back region 96, which is positioned on a back side of the protrusion 92, of the first locking lance 81. Note that the protrusion back region 96 is a region of the first locking lance 81 which overlaps a formation range of the protrusion 92 when viewed from a thickness direction of the arm 90. The crush rib 70 pressurizes the first locking lance 81 to maintain a state in which the first lance projection 91 enters the first locking recess 82 and the first locking lance 81 is pressurized against the inner circumferential surface of the enclosure 51. In the present embodiment, the state in which the first locking lance 81 is pressed against the inner circumferential surface of the enclosure 51 is a state in which the protrusion 92 abuts on the inner circumferential surface of the enclosure 51.

A tip end portion of the restrictor 64 tapers such that a thickness thereof in the Z direction decreases toward the +X direction. The tip end portion of the restrictor 64 has, toward the −X direction, a sliding surface 65 extending toward the enclosure 51 (outward in the Z direction) when viewed from the X direction. In a process of inserting the insertion portion 62 into the inner side of the circular cylinder 22, the inclined portion 95 of the tip end of the first locking lance 81 slides on the sliding surface 65 and is pressurized toward the enclosure 51 (outward in the Z direction) while crushing the crush rib 70.

Note that, in the half-fitted state of the housing 10 and the shell 50, the tip end of the first locking lance 81 is located on the inner side deeper than a normal position, and the tip end portion of the restrictor 64 abuts on the tip end surface 81a of the first locking lance 81 in the process of inserting the insertion portion 62 into the circular cylinder 22. The tip end portion of the restrictor 64 abuts on the tip end surface 81a of the first locking lance 81, thereby restricting insertion of the insertion portion 62 into the circular cylinder 22. In the half-fitted state of the housing 10 and the shell 50, the insertion of the insertion portion 62 into the circular cylinder 22 is restricted in a state in which the rear holder 60 is located at a position in the −X direction from a normal position with respect to the shell 50 and the housing 10.

As illustrated in FIGS. 5, 7, and 8, the housing 10 and the rear holder 60 include second engagement portions 85 that engage with each other. A plurality of the second engagement portions 85 are provided in the Z direction and, a plurality of the second engagement portions 85 are provided in the Y direction. The second engagement portion 85 includes a second locking lance 86 provided in the rear holder 60 and a second locking recess 87 provided in the housing 10.

As illustrated in FIGS. 7 and 8, the second locking lances 86 are provided at the insertion portions 62. The second locking lances 86 are provided at end portions of the insertion portions 62 in the +Z direction and in the −Z direction. The second locking lance 86 has a cantilever shape with an end portion in the +X direction as a base end (a fixed end). The second locking lance 86 is connected to an opening edge of a recess formed in an outer circumferential surface of the insertion portion 62. The second locking lance 86 is formed in a plate shape having a thickness in the Z direction. The second locking lance 86 can be bent in the Z direction. The second locking lance 86 has a second lance projection 88. The second lance projection 88 projects outward from the outer circumferential surface of the insertion portion 62 toward the circular cylinder 22 when viewed from the X direction. The second lance projection 88 projects outward in the Z direction from the outer circumferential surface of the insertion portion 62. The second locking lance 86 is bent in the Z direction, thereby enabling the second lance projection 88 to be elastically displaced inward to be separated from the circular cylinder 22.

As illustrated in FIGS. 5 and 8, the second locking recess 87 is provided in the outer circumferential wall portion 25 of the electric wire accommodator 21 of the housing 10. The second locking recess 87 is open in the inner circumferential surface of each circular cylinder 22. The second locking recess 87 is formed at a position opposite to the second lance projection 88 in the inner circumferential surface of the circular cylinder 22. In the present embodiment, the second locking recess 87 penetrates the circular cylinder 22 in a radial direction of the circular cylinder 22. In the completely fitted state of the housing 10 and the rear holder 60, the second lance projection 88 enters the second locking recess 87. An opening edge of the second locking recess 87 engages with the second lance projection 88 from the −X direction, thereby restricting movement of the rear holder 60 in the −X direction with respect to the housing 10.

As illustrated in FIGS. 2 and 9, the rear holder 60 is formed by combining two parts to sandwich the electric wire 41 from both sides in the Z direction. In other words, the rear holder 60 is formed to be dividable into two parts. The two parts forming the rear holder 60 are formed to collectively sandwich all the electric wires 41 arranged in the Y direction from both sides in the Z direction. The rear holder 60 holds the electric wires 41 by sandwiching the electric wires 41 between the two parts.

In the present embodiment, the housing 10 has the first locking lance 81 that extends along the inner circumferential surface of the enclosure 51 of the shell 50 and engages with the enclosure 51. The rear holder 60 has the crush rib 70 that is disposed inside the electric wire accommodator 21 and pressurizes the first locking lance 81 toward the inner circumferential surface of the enclosure 51. According to such a configuration, since the first locking lance 81 is reliably sandwiched between the enclosure 51 and the crush rib 70, the occurrence of rattling between the housing 10 and the shell 50 and between the housing 10 and the rear holder 60 can be avoided. Therefore, the electric wires 41 held by the rear holder 60 are fixed to the shell 50 and the housing 10. Hence, it is possible to prevent such a matter as vibration of the electric wires 41 being transmitted to the terminals 40 without being restrained by the rear holder 60.

The first locking lance 81 has the protrusion 92 that abuts on the inner circumferential surface of the enclosure 51. According to such a configuration, for example, compared with a configuration in which a flat surface of a locking lance comes into contact with the inner circumferential surface of the enclosure 51, the first locking lance 81 can be strongly pressed against the inner circumferential surface of the enclosure 51. Hence, rattling between the housing 10 and the shell 50 and between the housing 10 and the rear holder 60 can be more reliably avoided.

The crush rib 70 is in contact with a protrusion back region 96, which is positioned on a back side of the protrusion 92, in the first locking lance 81. According to such a configuration, the position in the first locking lance 81 at which the protrusion 92 is provided can be reliably sandwiched between the enclosure 51 and the crush rib 70. Hence, rattling between the housing 10 and the shell 50 and between the housing 10 and the rear holder 60 can be more reliably avoided.

The rear holder 60 has the restrictor 64 including the crush rib 70. The housing 10 has the inner linker 24 that comes into contact with the restrictor 64 from the opposite side to the first locking lance 81 with respect to the restrictor 64. According to such a configuration, the inner linker 24 can restrict displacement of the restrictor 64 such that the crush rib 70 is separated from the first locking lance 81. Hence, the crush rib 70 can reliably pressurize the first locking lance 81.

The restrictor 64 abuts on the tip end surface 81a of the first locking lance 81 in the half-fitted state of the housing 10 and the shell 50. According to such a configuration, the insertion of the restrictor 64 into an inner side of the electric wire accommodator 21 can be avoided in the half-fitted state of the housing 10 and the shell 50. Therefore, in the half-fitted state of the housing 10 and the shell 50, insertion and crushing of the crush rib 70 into an inner side of the first locking lance 81 can be prevented. Hence, unnecessary wear of the rear holder 60 can be prevented.

In the above-described embodiment, the protrusion 92 is provided on the first locking lance 81. However, the protrusion may not be provided on the first locking lance, and for example, the arm of the first locking lance may come into contact with an inner surface of the shell 50. In such a configuration, the crush rib 70 is brought into contact with a region of the first locking lance, the region being positioned on a back side of a position of the first locking lance which is in contact with the inner surface of the shell 50, thereby enabling the first locking lance to be reliably sandwiched between the shell 50 and the crush rib 70.

In the above-described embodiment, the housing 10 is formed to allow the electric wire 41 to be pulled out in the −X direction. However, the housing may be formed to allow the electric wire to be pulled out in a direction intersecting the X direction. That is, the electric wire accommodator of the housing may not be provided behind (in the −X direction of) the terminal support that supports the terminal.

In the above-described embodiment, the first locking lance 81 is disengaged from the enclosure 51 in the Z direction, and the crush rib 70 is configured to pressurize the first locking lance 81 in the Z direction. However, the crush ribs may be formed to pressurize the locking lance that is disengaged from the shell in a direction other than the Z direction (for example, the Y direction).

Several embodiments and modification examples have been described above. However, the embodiments and the modification examples are not limited to the examples described above. For example, a plurality of embodiments may be realized in combination with each other. The above-described embodiments can be implemented in various other forms, and various additions, omissions, substitutions, and modifications can be performed without departing from the gist of the disclosure.

### INDUSTRIAL APPLICABILITY

According to the disclosure, transmission of vibration from an electric wire to a terminal can be suppressed.

### REFERENCE SIGNS LIST

1 connector
10 housing
11 front portion (terminal support)
21 electric wire accommodator
24 inner linker (contact portion)
40 terminal
41 electric wire
50 shell
60 rear holder (holder)
64 restrictor
70 crush rib
81 first locking lance (locking lance)
92 protrusion
96 protrusion back region

What is claimed is:

1. A connector comprising:
a housing having a terminal support that supports a terminal, and an electric wire accommodator through which an electric wire connected to the terminal passes;
a shell fitted on an outer side of the electric wire accommodator from an opposite side of the terminal support; and
a holder that holds the electric wire and is fitted in an inner side of the electric wire accommodator;
wherein the housing has a locking lance that extends along an inner surface of the shell and engages with the shell, and
the holder has a crush rib that is disposed inside the electric wire accommodator and pressurizes the locking lance toward the inner surface of the shell.

2. The connector according to claim 1, wherein
the locking lance has a protrusion that abuts on the inner surface of the shell.

3. The connector according to claim 2, wherein
the locking lance has a protrusion back region positioned on a back side of the protrusion, and
the crush rib is in contact with the protrusion back region.

4. The connector according to claim 1, wherein
the holder has a restrictor which is inserted into an inner side of the electric wire accommodator and on which the crush rib is provided, and
the housing has a contact portion that comes into contact with the restrictor from an opposite side to the locking lance with respect to the restrictor.

5. The connector according to claim 1, wherein
the holder has a restrictor which is inserted into an inner side of the electric wire accommodator and on which the crush rib is provided, and
the restrictor abuts on a tip end of the locking lance in a half-fitted state of the housing and the shell in which the locking lance does not engage with the shell.
